(19) United States
(12) Patent Application Publication
(10) Pub. No.: US 2011/0290668 A1
(43) Pub. Date: Dec. 1, 2011

(54) ANALYTICAL TEST STRIP WITH CROSSROADS EXPOSED ELECTRODE CONFIGURATION

(75) Inventors: James MOFFAT, Iverness (GB); Lynsey Whyte, Newtonmore (GB); Robert Marshall, Conon Bridge (GB); Steven Setford, Fortrose (GB)

(73) Assignee: LifeScan Scotland Limited, Inverness (GB)

(21) Appl. No.: 12/788,639

(22) Filed: May 27, 2010

(51) Int. Cl. G01N 27/26

(52) U.S. Cl. 205/777.5; 204/403.02; 205/792; 205/782

(57) ABSTRACT

An electrochemical-based analytical test strip for the determination of an analyte (such as glucose) in a bodily fluid sample (for example, whole blood) includes an electrically insulating base layer, a patterned conductor layer disposed over the electrically-insulating layer, and a patterned insulation layer, with an electrode exposure window therethrough, disposed over the patterned conductor layer. The patterned conductive layer of the electrochemical-based analytical test strip includes at least one working electrode and a counter/reference electrode. In addition, at least a portion of the electrode exposure window is configured to expose a working electrode exposed portion and a counter/reference electrode exposed portion, with the working electrode exposed portion being rectangular in shape and the counter/reference electrode exposed portion being one of a crossroads shape and an at least six-sided portion of a crossroads shape.

### BACKGROUND OF THE INVENTION

1. Field of the Invention

The present invention relates, in general, to medical devices and, in particular, to analytical test strips and related methods.

2. Description of Related Art

The determination (e.g., detection and/or concentration measurement) of an analyte in a fluid sample is of particular interest in the medical field. For example, it can be desirable to determine glucose, ketone bodies, cholesterol, lipoproteins, triglycerides, acetaminophen and/or HbA1c concentrations in a sample of a bodily fluid such as urine, blood, plasma or interstitial fluid. Such determinations can be achieved using analytical test strips, based on, for example, visual, photometric or electrochemical techniques. Conventional electrochemical-based analytical test strips are described in, for example, U.S. Pat. Nos. 5,708,247, and 6,284,125, each of which is hereby incorporated in full by reference.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention, in which:

FIG. 1 is a simplified exploded view of an electrochemical-based analytical test strip according to an embodiment of the present invention;

FIG. 2A is a simplified top view of the patterned conductor layer of the electrochemical-based analytical test strip of FIG. 1;

FIG. 2B is a simplified top view of the patterned conductor layer and patterned insulation layer, with crossroads shaped electrode exposure window therethrough, of the electrochemical-based analytical strip of FIG. 1 wherein the patterned insulation layer has nominal registration (i.e., perfectly meets predetermined specifications with respect to registration) with the patterned conductor layer;

FIG. 2C is a simplified top view of the patterned conductor layer, patterned insulation layer, and patterned adhesive layer of the electrochemical-based analytical strip of FIG. 1 wherein the patterned insulation layer and patterned adhesive layer both have nominal registration (also referred to as nominal alignment) with the patterned conductor layer;

FIG. 3A is a simplified top view of the patterned conductor layer of the electrochemical-based analytical test strip of FIG. 1;

FIG. 3B is a simplified top view of the patterned conductor layer and patterned insulation layer, with crossroads shaped electrode exposure window therethrough, of the electrochemical-based analytical strip of FIG. 1 wherein the patterned insulation layer has worst-case registration (i.e., the largest allowable offset from nominal registration and which is, therefore, the most unfavorable registration) with the patterned conductor layer;

FIG. 3C is a simplified top view of the patterned conductor layer, patterned insulation layer, and patterned adhesive layer of the electrochemical-based analytical strip of FIG. 1 wherein the patterned insulation layer and patterned adhesive layer both have worst-case registration with the patterned conductor layer;

FIG. 4 is a simplified depiction of a meter (i.e., associated meter) that can be employed with electrochemical-based analytical test strips according to embodiments of the present invention;

FIG. 5 is a simplified depiction of the patterned conductor layer of the electrochemical-based analytical test strip of FIG. 1 interfacing with an associated meter; and

FIG. 6 is a flow diagram depicting stages in a method for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein

In general, electrochemical-based analytical test strips for the determination of an analyte (such as glucose) in a bodily fluid sample (for example, whole blood) according to embodiments of the present invention include an electrically insulating base layer, a patterned conductor layer disposed over the electrically-insulating layer, and a patterned insulation layer, with an electrode exposure window therethrough, disposed over the patterned conductor layer. The patterned conductive layer of the electrochemical-based analytical test strip includes at least one working electrode and a counter/reference electrode. In addition, at least a portion of the electrode exposure window is configured to expose a working electrode exposed portion and a counter/reference electrode exposed portion, with the working electrode exposed portion being rectangular in shape and the counter/reference electrode exposed portion being one of a crossroads shape and an at least six-sided portion of a crossroads shape.

Electrochemical-based analytical test strips according to embodiments of the present invention are beneficial in that, for example, the crossroads-based shape of the counter/reference electrode exposed portion results in minimal variability in the area of the counter/reference electrode exposed portion across manufacturing registration tolerances while simultaneously reducing sample-receiving chamber volume. In other words, although the area of the counter/reference electrode exposed area varies across the manufacturing registration tolerance, the area remains within an acceptable range across the allowable manufacturing specification for registration of the various layers (i.e., from a nominal registration scenario to a worse case registration scenario) of the electrochemical-based analytical test strip. Moreover, the crossroads-based shape enables an electrochemical-based analytical test strip configuration wherein the counter/reference electrode width is minimized, thus reducing the total volume (typically≧1.0 μL in embodiments of the present invention) of the electrochemical-based analytical test strip's sample-receiving chamber. Conventional rectangular shaped counter/reference electrode exposed areas may maintain a constant area across the allowable manufacturing specification for registration, but their rectangular configuration comes at the expense of requiring a relatively large and, thus, undesirable sample-receiving chamber volume.

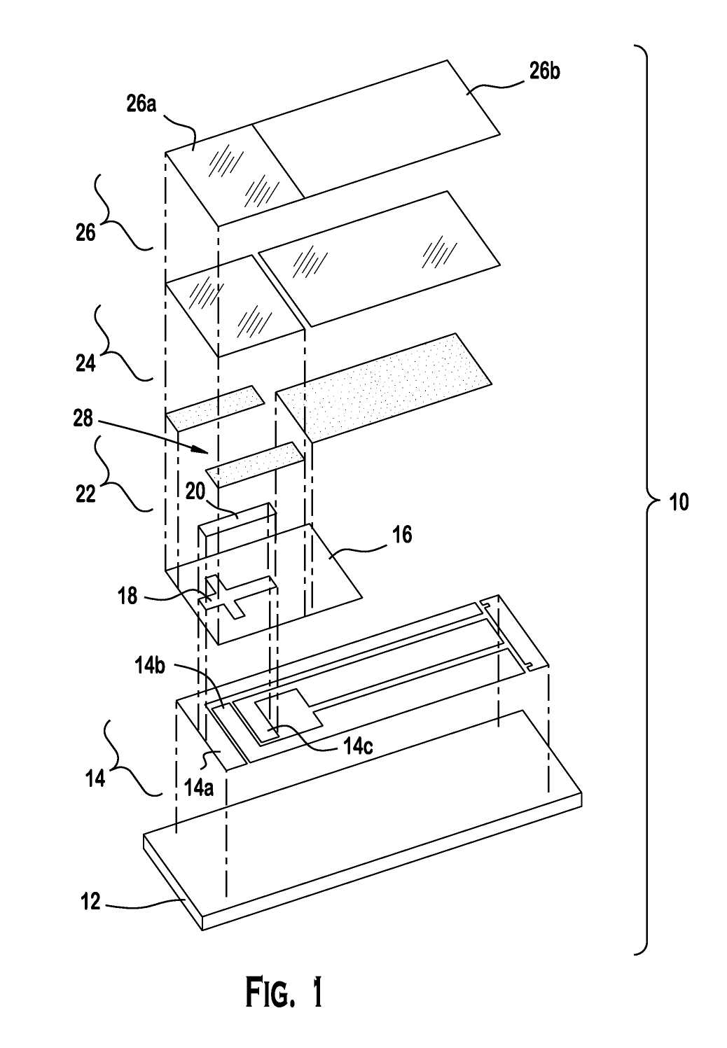

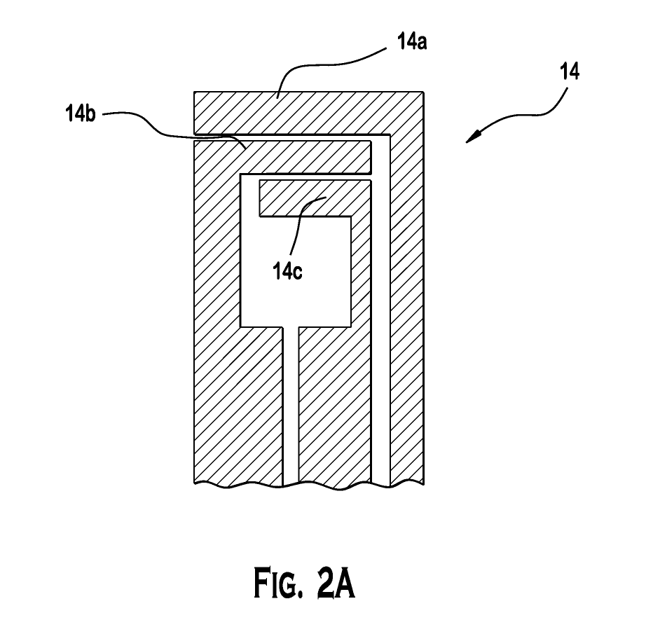

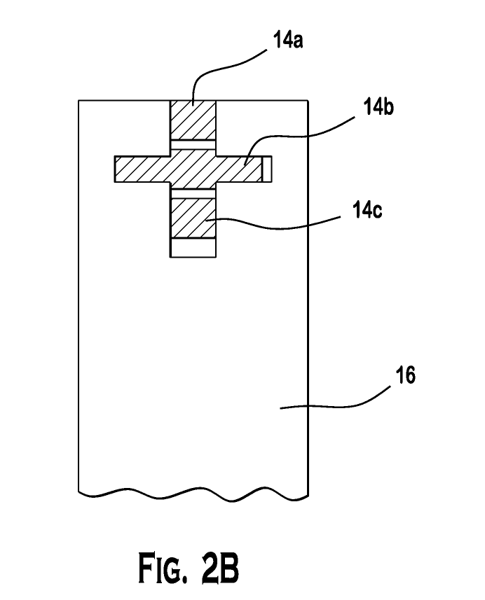

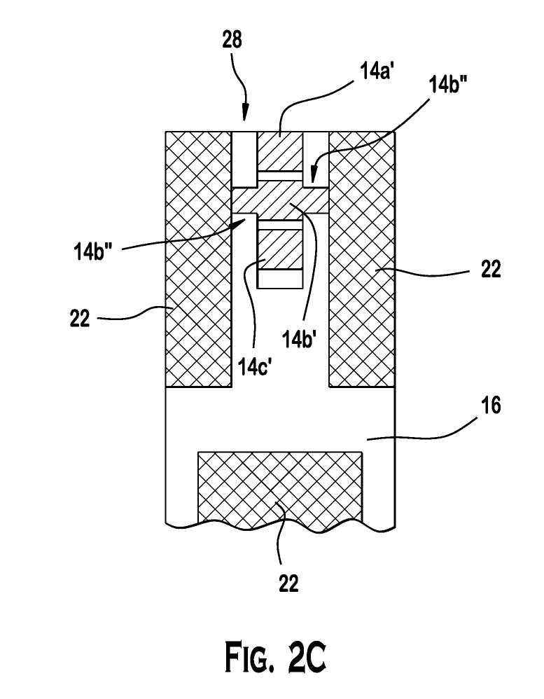

FIG. 1 is a simplified exploded view of an electrochemical-based analytical test strip 10 according to an embodiment of the present invention. FIG. 2A is a simplified top view of the patterned conductor layer of electrochemical-based analytical test strip 10. FIG. 2B is a simplified top view of the patterned conductor layer and patterned insulation layer, with crossroads shaped electrode exposure window therethrough, of electrochemical-based analytical strip 10. FIG. 2C is a simplified top view of the patterned conductor layer, patterned insulation layer, and patterned adhesive layer of electrochemical-based analytical strip 10. In FIGS. 2B and 2C, the patterned insulation layer and both the patterned insulation layer and the patterned adhesive layer, respectively, have nominal registration (nominal alignment) with the patterned conductor layer.

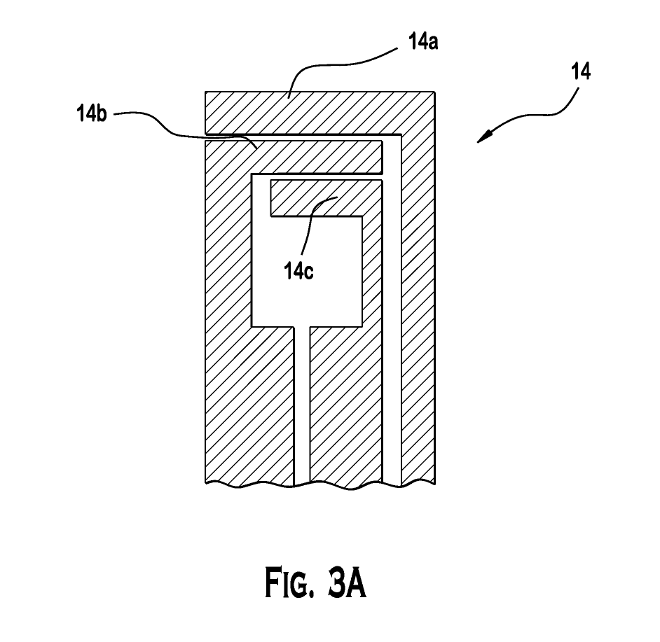

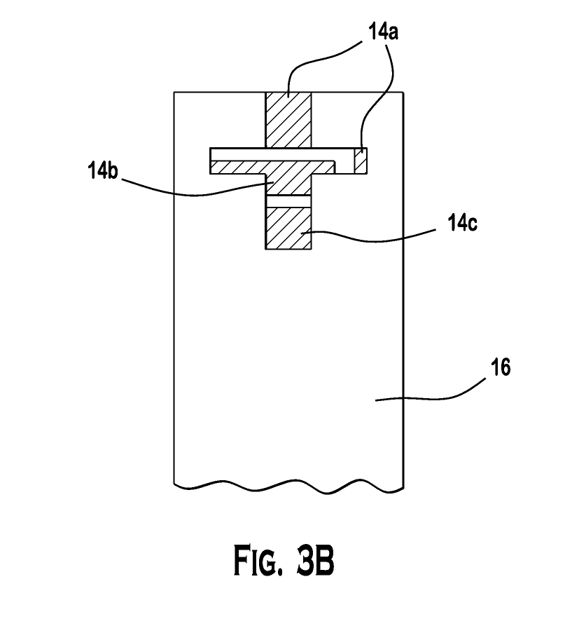

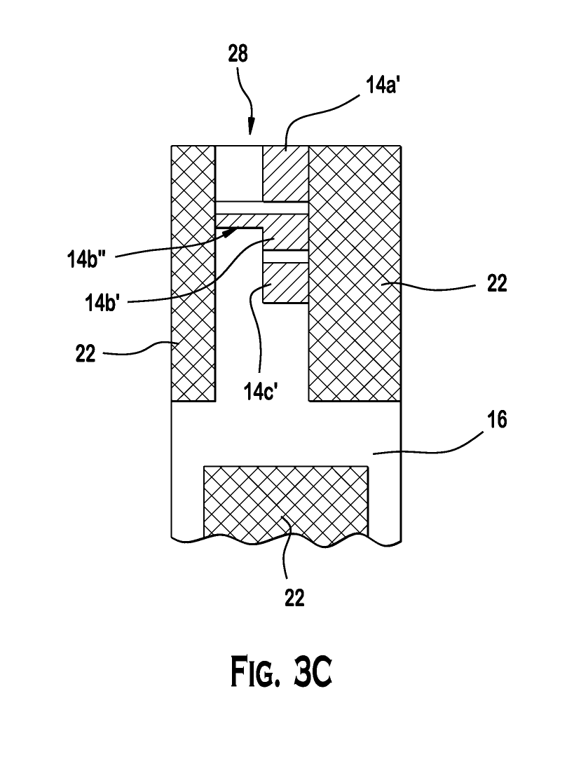

FIG. 3A is a simplified top view of the patterned conductor layer of the electrochemical-based analytical test strip 10. FIG. 3B is a simplified top view of the patterned conductor layer and patterned insulation layer, with crossroads shaped electrode exposure window therethrough, of electrochemical-based analytical strip 10. FIG. 3C is a simplified top view of the patterned conductor layer, patterned insulation layer and patterned adhesive layer of electrochemical-based analytical strip 10. In FIGS. 3B and 3C, the patterned insulation layer and both the patterned insulation layer and the patterned adhesive layer, respectively, have worst-case specified registration (i.e., largest allowable mis-registration/misalignment during manufacturing and, therefore, most unfavorable scenario) with the patterned conductor layer

Referring to FIGS. 1, 2A-C, and 3A-C, electrochemical-based analytical test strip 10 for the determination of an analyte (such as glucose) in a bodily fluid sample (for example, a whole blood sample) includes an electrically-insulating substrate 12, a patterned conductor layer 14, a patterned insulation layer 16 with electrode exposure window 18 therethrough, an enzymatic reagent layer 20, a patterned adhesive layer 22, a hydrophilic layer 24, and a top layer 26.

The disposition and alignment of electrically-insulating substrate 12, patterned conductor layer 14 (which includes a first working electrode 14a, a counter/reference electrode 14b and a second working electrode 14c, see FIGS. 2A and 3A in particular), patterned insulation layer 16 (with electrode exposure window 18 extending therethrough), enzymatic reagent layer 20, patterned adhesive layer 22, hydrophilic layer 24 and top layer 26 of electrochemical-based analytical test strip 10 are such that sample-receiving chamber 28 is formed within electrochemical-based analytical test strip 10.

In the embodiment of FIGS. 1, 2A-2C and 3A-3C, patterned conductor layer 14 includes a first working electrode 14a, a counter/reference electrode 14b, and a second working electrode 14c. Although electrochemical-based analytical test strip 10 is depicted as including three electrodes, embodiments of electrochemical-based analytical test strips, including embodiments of the present invention, can include any suitable number of electrodes.

First working electrode 14a, counter/reference electrode 14b, and second working electrode 14c can be formed of any suitable material including, for example, gold, palladium, platinum, indium, titanium-palladium alloys and electrically conducting carbon-based materials. Referring in particular to FIGS. 2C and 3C, electrode exposure window 18 of patterned insulation layer 16, in combination with patterned adhesive layer 22, exposes a portion of counter/reference electrode 14b, a portion of first working electrode 14a and a portion of second working electrode 14c, namely counter/reference electrode exposed portion 14b′, first working electrode exposed portion 14a′ and second working electrode exposed portion 14c′, respectively. During use, a bodily fluid sample is applied to electrochemical-based analytical test strip 10 and transferred to sample-receiving chamber 28, thereby operatively contacting counter/reference electrode exposed portion 14b′, first working electrode exposed portion 14a′ and second working electrode exposed portion 14c′.

In electrochemical-based analytical test strip 10, electrode exposure window 18 is of a crossroads shape. Such a crossroads shape can also be thought of as a “plus” sign shape, a “cross” shape or as a shape consisting of two intersecting rectangles. In the perspective of FIGS. 2A-2C and 3A-3C and considering the shape to be a “cross”, such an electrode exposure window can also be thought of as consisting of a central portion that is rectangular in shape, a left-hand-side lateral arm and a right-hand lateral side arm.

The crossroads shape of electrode exposure window 18 results in counter/electrode exposed portion 14b′ having a crossroads shape in a scenario of nominal registration during manufacturing (see the sequence of FIGs. from 2A through 2C) and a six-sided portion of crossroads shape in the scenario of worst case registration (see the sequence of FIGs. From 3A through 3C). Once apprised of the present invention, one skilled in the art will recognize that for scenarios between nominal registration and worst case registration, the shape of the counter/reference electrode exposed portion may be a subportion of a cross-roads shape that has more than six sides but in embodiments of the present invention will be an at least six-sided portion of a cross-roads shape. As mentioned above, the crossroads shape of the electrode exposure window and resulting crossroads (or at least six-sided portion of crossroads shape) of the counter/reference electrode exposed portion provides low variability in the area of the counter/reference electrode exposed portion area. This low variability results in an acceptable range for the area ratio of the counter/reference electrode and either of the first working electrode and the second working electrode.

In the embodiment of FIGS. 2A-2C, the crossroads shape of electrode exposure window 18 results in a counter/reference electrode exposed portion that includes extension portions 14b″ that extend laterally (left to right in FIGS. 2A-2C) beyond the furthermost lateral position of the first working electrode exposed portion and the second working electrode exposed portion. These lateral extensions increase the area of the counter/reference electrode exposed portion while minimizing the width (as measured in the vertical direction of FIGS. 2A-2C) of the counter/electrode electrode and, thus, the volume of sample-receiving chamber 28.

In the embodiment of FIGS. 3A-3C, the crossroads shape of electrode exposure window 18 results in a counter/reference electrode exposed portion that has a single portion 14b″ which extend laterally (to the left in FIGS. 3A-3C) beyond the furthermost lateral position of the first working electrode exposed portion and the second working electrode exposed portion. This lateral extension increases the area of the counter/reference electrode exposed portion while minimizing the width (as measured in the vertical direction of FIGS. 3A-3C) of the counter/electrode electrode and, thus, the volume of the sample-receiving chamber. The shape of the counter/reference electrode exposed portion in FIG. 3C (i.e., element 14b′ in FIG. 3C) is referred to herein as a six-sided portion of a cross-roads shape.

Referring to FIG. 3B, it can be seen that the worst-case specified registration results in a portion of first working electrode 14a being overlapped by the right-hand side lateral arm of electrode exposure window 18 and, therefore not covered by patterned insulation layer 16. This overlapped portion of first working electrode 14a is covered by patterned adhesive layer 22 (compare FIGS. 3B and 3C) and, therefore, does not function as an electrochemically active electrode area during use of electrochemical-based analytical test strip 10. However, if desired to avoid such an overlap and any registration restrictions it may bring about, crossroads shape electrode exposure window 18 can be of a suitable asymmetrical crossroads that avoids such an overlap. For example, the right-hand side lateral arm of the crossroads shaped electrode exposure window can be configured as slightly shorter (measured left-to-right in the perspective of FIGS. 2A-2C and 3A-3C) than the left hand-side lateral arm such that the right-hand-side lateral arm does not overlap a portion of the first working electrode.

The following is a non-limiting numerical example of typically dimensions and spacings for the nominal scenario of FIGS. 2A-2C and the worst-case scenario of FIGS. 3A-3C, as well as the resulting counter/reference exposed portion area, first working electrode exposed portion area and second working electrode exposed area.

Referring to FIGS. 2A-2C, sample-receiving chamber 28 has an illustrative, but non-limiting, width of 1.92 mm (measured left-to-right in FIGS. 2A-2C), length of 3.105 mm (measured top-to-bottom in FIGS. 2A-2C) and height of 119 μm (measured perpendicular to the plane of FIGS. 2A-2C and, therefore, not depicted in FIGS. 2A-2C). Therefore the volume of the sample-receiving chamber is 0.709 μL. First working electrode exposed portion 14a′ has an illustrative, but non-limiting, width of 0.8 μm and length of 0.8 μm and, therefore, an area of 0.64 mm². Second working electrode exposed portion 14c′ has an illustrative, but non-limiting, width of 0.8 μm and length of 0.8 μm and, therefore, an area of 0.64 mm². In the embodiment of FIGS. 2A-2C, the counter/reference electrode exposed portion has two lateral extensions 14b″ (each 0.43 μm by 0.56 μm) with the remainder of counter/reference electrode exposed portion 14b′ being 0.8 μm by 0.73 μm, for a total area of 1.066 mm². The ratio of counter/reference electrode exposed portion to either of the first and second working electrode exposed portion is, therefore, 1.665 to 1.

Referring to FIGS. 3A-3C, the worst case scenario is based on patterned insulation layer 16 shifted right by 300 μm and upward by 350 μm in comparison to FIGS. 2A-2C and patterned adhesive layer 22 being shifted left by 260 μm in comparison to FIGS. 2A-2C. In the embodiment of FIGS. 3A-3C, sample-receiving chamber 28 has an illustrative, but non-limiting, width of 1.92 mm, length of 3.105 mm and height of 119 μm. Therefore the volume of the sample-receiving chamber is 0.709 μL. First working electrode exposed portion 14a′ has a width of 0.8 μm and a length of 0.8 μm and, therefore, an area of 0.64 mm². Second working electrode exposed portion 14c′ has a width of 0.8 μm and a length of 0.8 μm and, therefore, an area of 0.64 mm². The counter/reference electrode exposed portion has one lateral extension 14b″ (1.12 μm by 0.23 μm), with the remainder of counter/reference electrode exposed portion 14b′ being 0.8 μm by 0.73 μm, for a total area of 0.8416 mm². The ratio of counter/reference electrode exposed portion to either of the first and second working electrode exposed portions is, therefore, 1.315 to 1. Once apprised of the present disclosure, one skilled in the art will recognize that maintaining an acceptable ratio of the counter/reference exposed portion to the first and/or second working electrode exposed portion is a factor in maintaining linearity, dynamic range and other aspects of an electrochemical-based analytical test strips' analytical performance. However, it has been determined that this ratio can vary within acceptable limits without compromising analytical performance. One skilled in the art will also recognize that the dimensions, areas and ratios described above are illustrative of particular embodiments and that such dimensions are, in general, a function of, for example, the analyte being determined, the type of bodily fluid sample, and the manufacturing processes employed to create an electrochemical-based analytical test strip according to the present invention. For example, the width of the first working electrode exposed portion, second electrode exposed portion and remainder of counter/reference electrode exposed portion in the embodiment of FIGS. 2A-2C and 3A-3C could be reduced to 0.7 μm while still providing the benefits described herein.

In both the embodiment of FIGS. 2A-2C and FIGS. 3A-3C, a relatively high ratio of counter/reference electrode exposed area to first and second working electrode exposed area is provided even though the width of the counter/reference electrode (i.e., 0.73 μm measured top-to-bottom in the perspective of FIGS. 2A-2C and 3A-3C) is significantly less than the width of the first and second working electrodes (i.e., 0.80 μm, also measured top-to-bottom in the perspective of FIGS. 2A-2C and 3A-3C). In addition and as described earlier, the relatively small width of the counter/reference electrode provides for a sample-receiving chamber that is beneficially low in total volume. It should be noted that to provide a counter/reference electrode exposed portion with an area ratio of 1.665 to 1 to a working electrode exposed portion while matching the length of the electrode's exposed portions at 0.8 μm (measured left-to-right in FIGS. 2A-2C and 3A-3C) would require a counter/reference electrode with a width of 1.332 μm and a commensurately larger sample-receiving chamber volume.

Electrically-insulating substrate 12 can be any suitable electrically-insulating substrate known to one skilled in the art including, for example, a nylon substrate, polycarbonate substrate, a polyimide substrate, a polyvinyl chloride substrate, a polyethylene substrate, a polypropylene substrate, a glycolated polyester (PETG) substrate, or a polyester substrate. The electrically-insulating substrate can have any suitable dimensions including, for example, a width dimension of about 5 mm, a length dimension of about 27 mm and a thickness dimension of about 0.5 mm.

Electrically-insulating substrate 12 provides structure to the strip for ease of handling and also serves as a base for the application (e.g., printing or deposition) of subsequent layers (e.g., a patterned conductor layer). It should be noted that patterned conductor layers employed in analytical test strips according to embodiments of the present invention can take any suitable shape and be formed of any suitable materials including, for example, metal materials and conductive carbon materials.

Patterned insulation layer 16 can be formed, for example, from a screen printable insulating ink. Such a screen printable insulating ink is commercially available from Ercon of Wareham, Mass. U.S.A. under the name “Insulayer.”

Patterned adhesive layer 22 can be formed, for example, from a screen-printable pressure sensitive adhesive commercially available from Apollo Adhesives, Tamworth, Staffordshire, UK. In the embodiment of FIGS. 1, 2A-2C and 3A-3C, patterned adhesive layer 22 defines outer walls of the sample-receiving chamber 28.

Hydrophilic layer 24 can be, for example, a clear film with hydrophilic properties that promote wetting and filling of electrochemical-based analytical test strip 10 by a fluid sample (e.g., a whole blood sample). Such clear films are commercially available from, for example, 3M of Minneapolis, Minn. U.S.A.

Enzymatic reagent layer 20 can include any suitable enzymatic reagents, with the selection of enzymatic reagents being dependent on the analyte to be determined. For example, if glucose is to be determined in a blood sample, enzymatic reagent layer 20 can include a glucose oxidase or glucose dehydrogenase along with other components necessary for functional operation. Enzymatic reagent layer 20 can include, for example, glucose oxidase, tri-sodium citrate, citric acid, polyvinyl alcohol, hydroxyl ethyl cellulose, potassium ferricyanide, antifoam, cabosil, PVPVA, and water. Further details regarding enzymatic reagent layers, and electrochemical-based analytical test strips in general, are in U.S. Pat. Nos. 6,241,862 and 6,733,655, the contents of which are hereby fully incorporated by reference.

Top layer 26 includes a first portion 26a (e.g. a transparent or translucent first portion) and an opaque second portion 26b. First portion 26a and the opaque second portion 26b of the top layer are configured and aligned with the remainder of the analytical test strip such that a user can view the sample-receiving chamber through the first portion of the top layer. Top layer 26 can be, for example, a clear film, with opaque second portion 26b being created, for example, by overprinting of the clear film with an opaque ink and first portion 26a being simply clear film without overprinting. A suitable clear film is commercially available from Tape Specialities, Tring, Hertfordshire, UK.

Electrochemical-based analytical test strip 10 can be manufactured, for example, by the sequential aligned formation of patterned conductor layer 14, patterned insulation layer 16 (with electrode exposure window 18 extending therethrough), enzymatic reagent layer 20, patterned adhesive layer 22, hydrophilic layer 24 and top film 26 onto electrically-insulating substrate 12. Any suitable techniques known to one skilled in the art can be used to accomplish such sequential aligned formation, including, for example, screen printing, photolithography, photogravure, chemical vapour deposition and tape lamination techniques.

During use of electrochemical-based analytical test strip 10 to determine an analyte concentration in a fluid sample (e.g., the determination of blood glucose concentration in a whole blood sample), electrodes 14a, 14b and 14c of patterned conductor layer 14 are employed by, for example, an associated meter to monitor an electrochemical response of the electrochemical-based analytical test strip, for example an electrochemical reaction induced current of interest. The magnitude of such a current can then be correlated with the amount of analyte present in the bodily fluid sample under investigation. During such use, a bodily fluid sample is introduced into sample-receiving chamber 28 of electrochemical-based analytical test strip 10.

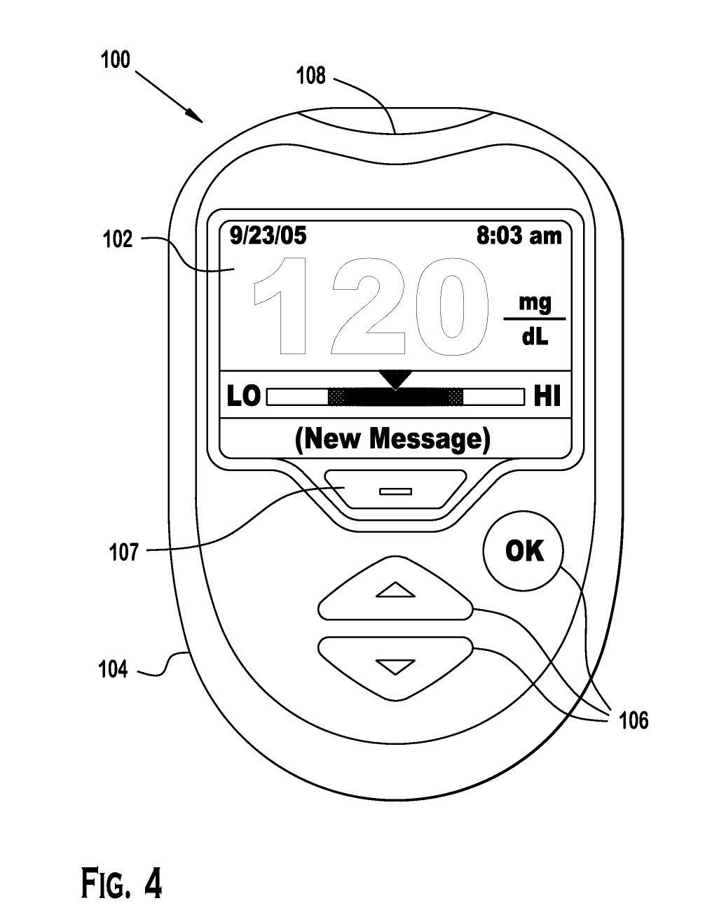

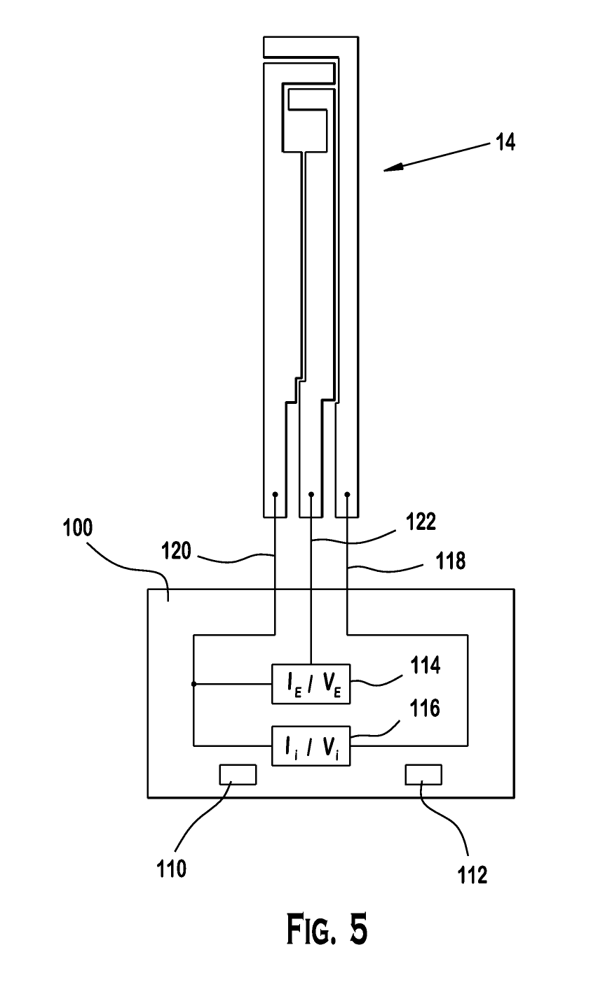

FIG. 4 is a simplified depiction of a meter 100 for use in combination with electrochemical-based analytical test strips according to embodiments of the present invention (also referred to as an “associated meter”). FIG. 5 is a simplified top view and block diagram illustrating patterned conductor layer 14 of electrochemical-based analytical test strip 10 interfacing with associated meter 100.

Meter 100 includes a display 102, a housing 104, a plurality of user interface buttons 106, an optional soft key 107 and a strip port connector 108. Meter 100 further includes electronic circuitry within housing 104 such as a memory 110, a microprocessor 112, electronic components 114 and 116 for applying a test voltage, and also for measuring a plurality of test current values. Electrochemical-based analytical test strip 10 is configured for operative insertion into strip port connector 108.

Memory 110 of meter 100 includes a suitable algorithm that determines an analyte based on the electrochemical response of electrochemical-based analytical test strip 10. The algorithm, therefore, accommodates the electrochemical response of the electrodes within electrochemical-based analytical test strip 10.

Meter 100 also includes a counter/reference electrode connector 118, a first working electrode connector 120 and a second working electrode connector 122. The three aforementioned connectors are part of strip port connector 108. When performing a test, a first test voltage source 114 may apply a plurality of test voltages Vᵢ between first working electrode 14a and counter/reference electrode 14b, wherein i ranges from 1 to n and more typically 1 to 5. As a result of the plurality of test voltages Vᵢ, meter 100 may then measure a plurality of test currents Iᵢ. In a similar manner, second test voltage source 116 may apply a test voltage V_{E} between second working electrode 14c and counter/reference electrode 14b. As a result of the test voltage V_{E}, meter 100 may then measure a test current I_{E}. Test voltages Vᵢ and V_{E} may be applied to first and second working electrodes, respectively, either sequentially or simultaneously. Those skilled in the art will recognize that the working electrode to which Vᵢ and V_{E} are applied may be switched, i.e., that Vᵢ may be applied to second working electrode and V_{E} may be applied to first working electrode.

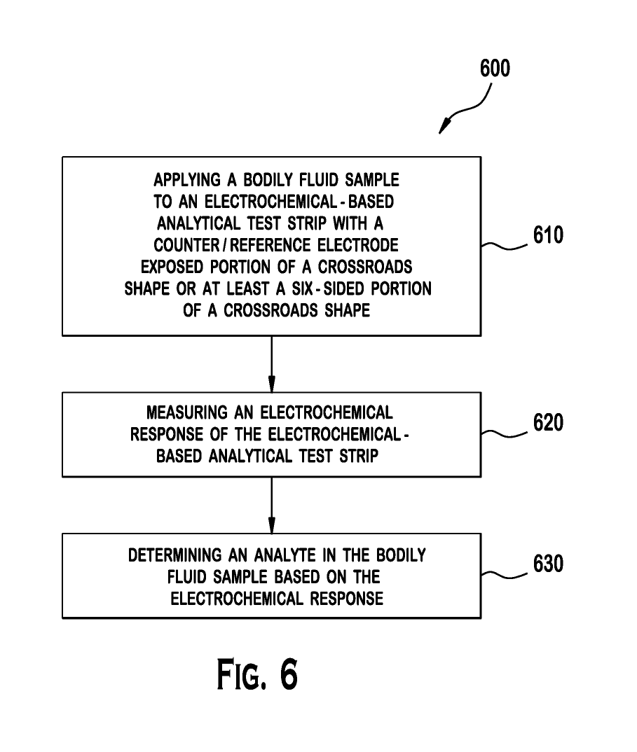

FIG. 6 is a flow diagram depicting stages in a method 600 for determining an analyte (such as glucose) in a bodily fluid sample according to an embodiment of the present invention. At step 610 of method 600, a bodily fluid sample (for example, a whole blood sample) is applied to an electrochemical-based analytical test strip. The electrochemical-based analytical test strip to which the bodily fluid sample is applied includes an electrically insulating base layer, a patterned conductor layer disposed over the electrically-insulating layer, and a patterned insulation layer, with an electrode exposure window therethrough, disposed over the patterned conductor layer. The patterned conductive layer of the electrochemical-based analytical test strip includes at least one working electrode and a counter/reference electrode. In addition, at least a portion of the electrode exposure window is configured to expose a working electrode exposed portion and a counter/reference electrode exposed portion, with the working electrode exposed portion being rectangular in shape and the counter/reference electrode exposed portion being one of a crossroads shape and an at least six-sided portion of a crossroads shape.

Method 600 also includes measuring an electrochemical response of the electrochemical-based analytical test strip (see step 6200f FIG. 6) and, at step 630, determining the analyte based on the measured electrochemical response. The measuring and determination steps (i.e., steps 620 and 630) can, if desired, by performed using a suitable associated meter such as meter 100 described above.

Once apprised of the present disclosure, one skilled in the art will recognize that method 600 can be readily modified to incorporate any of the techniques, benefits and characteristics of electrochemical-based analytical test strips according to embodiments of the present invention and described herein, as well as meters described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. An electrochemical-based analytical test strip for the determination of an analyte in a bodily fluid sample, the electrochemical-based analytical test strip comprising:
an electrically insulating base layer;
a patterned conductor layer disposed over the electrically-insulating layer, the patterned conductive layer including at least a working electrode and a counter/reference electrode; and
a patterned insulation layer disposed over the patterned conductor layer, the patterned insulation layer having an electrode exposure window therethrough,
wherein at least a portion of the electrode exposure window is configured to expose a working electrode exposed portion and a counter/reference electrode exposed portion, and
wherein the working electrode exposed portion is rectangular in shape and the counter/reference electrode exposed portion is one of a crossroads shape and an at least six-sided portion of a crossroads shape.

2. The electrochemical-based analytical test strip of claim 1 wherein the electrode exposure window is crossroads shaped.

3. The electrochemical-based analytical test strip of claim 1 wherein the counter/reference electrode exposed portion has a crossroads shape when the patterned insulation layer has nominal registration with the patterned conductor layer.

4. The electrochemical-based analytical test strip of claim 1 wherein the counter/reference electrode exposed portion has a six-sided portion of a crossroads shape when the patterned insulation layer has worst-case registration with the patterned conductor layer.

5. The electrochemical-based analytical test strip of claim 1 further including:
a patterned adhesive layer,
wherein the patterned adhesive layer and the electrode exposure window are configured to jointly define the counter/reference electrode exposed portion.

6. The electrochemical-based analytical test strip of claim 5 wherein the patterned adhesive layer is also configured to define a sample-receiving chamber.

7. The electrochemical-based analytical test strip of claim 1 wherein the patterned conductor layer includes a first working electrode, a second working electrode and a single counter/reference electrode, and
wherein the at least a portion of the electrode exposure window is configured to expose a first working electrode exposed portion and a second working electrode exposed portion, and
wherein the first working electrode exposed portion and the second working electrode exposed portion are rectangular in shape.

8. The electrochemical-based analytical test strip of claim 7 wherein the single counter/reference electrode is disposed between the first working electrode and the second working electrode.

9. The electrochemical-based analytical test strip of claim 8 wherein the electrode exposure window is crossroads in shape.

10. The electrochemical-based analytical test strip of claim 1 wherein the analyte is glucose and the bodily fluid sample is blood.

11. The electrochemical-based analytical test strip of claim 1 wherein the electrode exposure window has an asymmetric crossroads shape.

12. A method for determining an analyte in a bodily fluid sample, the method comprising:
applying a bodily fluid sample to an electrochemical-based analytical test strip having:
an electrically insulating base layer;
a patterned conductor layer disposed over the electrically-insulating layer, the patterned conductive layer including at least a working electrode and a counter/reference electrode; and
a patterned insulation layer disposed over the patterned conductor layer, the patterned insulation layer having an electrode exposure window therethrough,
wherein at least a portion of the electrode exposure window is configured to expose a working electrode exposed portion and a counter/reference electrode exposed portion, and
wherein the working electrode exposed portion is rectangular in shape and the counter/reference electrode exposed portion is one of a crossroads shape and an at least six-sided portion of a crossroads shape;
measuring an electrochemical response of the electrochemical-based analytical test strip; and
determining the analyte based on the measured electrochemical response.

13. The method of claim 12 wherein the analyte is glucose

14. The method of claim 13 wherein the bodily fluid sample is whole blood.

15. The method of claim 12 wherein the electrode exposure window is crossroads shaped.

16. The method of claim 12 wherein the counter/reference electrode exposed portion has a crossroads shape.

17. The method of claim 12 further including:
a patterned adhesive layer,
wherein the patterned adhesive layer and the electrode exposure window are configured to jointly define the counter/reference electrode exposed portion.

18. The method of claim 17 wherein the patterned adhesive layer is also configured to define a sample-receiving chamber.

19. The method of claim 12 wherein the patterned conductor layer includes a first working electrode, a second working electrode and a single counter/reference electrode, and
wherein the at least a portion of the electrode exposure window is configured to expose a first working electrode exposed portion and a second working electrode exposed portion, and
wherein the first working electrode exposed portion and the second working electrode exposed portion are rectangular in shape.

20. The method of claim 19 wherein the single counter/reference electrode is disposed between the first working electrode and the second working electrode.

21. The method of claim 20 wherein the electrode exposure window is crossroads in shape.

22. The method of claim 12 wherein the electrode exposure window has an asymmetric crossroads shape.
